(19) United States
(12) Patent Application Publication
(10) Pub. No.: US 2007/0002374 A1
(43) Pub. Date: Jan. 4, 2007

(54) Image forming system and method

(75) Inventor: Soon-kew Choi, Seongnam-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/477,464

(22) Filed: Jun. 30, 2006

(30) Foreign Application Priority Data
Jun. 30, 2005 (KR) 2005-58594

(51) Int. Cl. G06F 3/12

(52) U.S. Cl. 358/1.15; 358/402

(57) ABSTRACT

An image forming system and method, the method including determining whether printing environmental conditions given to a read-out image file are predetermined printing environmental conditions; uploading the image file if the given printing environmental conditions are the predetermined printing environmental conditions; image-processing the uploaded image file and downloading the image-processed image file; and forming an image of the downloaded image file, wherein the determining of the printing environmental conditions, the uploading of the image file, and the forming of the image are performed in a peripheral, and the image-processing of the uploaded image file is performed in a host connected to the peripheral. Accordingly, the peripheral reading an image file does not image-process the image file by using a decoder located therein but image-process the image file using a host connected thereto, so that even a large-sized image file can be rapidly image-processed. As a result, a high speed printing effect can be obtained. Particularly, since a software decoder located on a host is used, to process an image file when a large-sized image file such as image data is to be printed

### CROSS-REFERENCE TO RELATED APPLICATION

This application claims the benefit of Korean Patent Application No. 2005-58594, filed on Jun. 30, 2005, in the Korean Intellectual Property Office, the disclosure of which is incorporated herein by reference.

### BACKGROUND OF THE INVENTION

1. Field of the Invention

An aspect of the present invention relates to an image forming system having a peripheral such as a printer, and more particularly, to an image forming system and method for checking at least one attribute of an image file read by a peripheral and prepared printing environmental conditions, image-processing the image file by a host connected to the peripheral according to the result of checking the at least one attribute and prepared printing environmental conditions, and forming an image of the image file, that is, the image-processed image file, by the peripheral.

2. Description of the Related Art

A printer or a multi-function peripheral having a printing function (hereinafter, referred to as a printing apparatus) may print an image file transmitted from a host connected thereto or an image file read from a memory card connected thereto.

In particular, a photo printer can print an image file read from a memory card connected thereto. If the memory card is located in a digital camera and the digital camera is connected to the photo printer, the photo printer can print an image file transmitted from the digital camera connected thereto.

As a result, the photo printer can print the image file read from the host as well as the image file transmitted from the host. For the printing, there is the need of a task (that is, image-processing) for converting the image file into a format which the photo printer can recognize. The image-processing may be referred to as rendering. Namely, in case of a photo printer, in order to print the read-out image file, it is necessary to image-process the read-out image file and thereafter print the image-processed image file.

The image-processing is performed by a decoder, and the decoder may be implemented in the photo printer in the form of hardware or in the form of software. A rendering or processing speed of a software decoder is much slower than a rendering or processing speed of a hardware decoder.

In a conventional image forming system, since image processing of an image file is always performed by a printing apparatus that reads the image file, there is a limitation on improving printing speed. This problem becomes more serious when the size of the image file is large.

### SUMMARY OF THE INVENTION

An aspect of the present invention provides an image forming system for checking at least one attribute of an image file read by a peripheral and prepared printing environmental conditions, image-processing the read image file by a host connected to the peripheral according to the result of checking the at least one attribute and prepared printing environmental conditions, and forming an image of the image file, that is, the image-processed image file, by the peripheral.

Another aspect of the present invention provides an image forming method for checking attributes of an image file read by a peripheral and prepared printing environmental conditions, image-processing the read image file by a host connected to the peripheral according to the result of checking the at least one attribute and prepared printing environmental conditions, and forming an image of the image file, that is, the image-processed image file, by the peripheral.

According to another aspect of the present invention, there is provided a computer-readable medium having embodied thereon a computer program for checking at least one attribute of an image file read by a peripheral and prepared printing environmental conditions, image-processing the image file by a host connected to the peripheral according to the result of checking the at least one attribute and prepared printing environmental conditions, and forming an image of the image file, that is, the image-processed image file, by the peripheral.

According to another aspect of the present invention, there is provided an image forming system including a peripheral checking whether or not an input image file is to be uploaded by using at least one attribute and printing environmental conditions of the image file, transmitting the image file according to the result of checking the at least one attribute and prepared printing environmental conditions, and forming an image of an image-processed image file; and a host connectable to the peripheral, rendering the transmitted image file, and outputting the rendered image file as the image-processed image file to the peripheral.

In the aforementioned aspects of the present invention, the peripheral may include a checking unit checking whether or not the image file is to be uploaded using at least one attribute and the printing environmental conditions of the image file; an uploading unit transmitting the image file according to the result of checking the at least one attribute; and an image forming unit forming the image of the image-processed image file.

According to another aspect of the present invention, the peripheral may render the image file, if the image file is not to be uploaded, and form the image of an image-processed image file.

According to another aspect of the present invention, the printing environmental conditions may include at least one of determining whether the rendering is available on hardware provided on the peripheral and whether the host is connected to the peripheral.

According to another aspect of the present invention, the attributes may include at least one of a file format and a size of the input image file.

According to another aspect of the present invention, the host may further include a PC interface which receives a selection of whether the host performs the rendering of the input image file. In addition, the peripheral may further include a memory card interface displaying an image file read from a storage medium connected to the peripheral.

According to another aspect of the present invention, there is provided an image forming method including determining whether a given image file is to be uploaded using at least one attribute of the image file or printing environmental conditions; uploading the image file if the read image file is to be uploaded; generating an image-processed image file by rendering the uploaded image file and transmitting the generated image file; and forming an image of the transmitted image-processed image file.

In the aforementioned aspects of the present invention, the determining of whether the image file it to be uploaded, the uploading of the read image file, and the forming of the image are performed in a peripheral, and the generating of the image-processed image file is performed in a host connected to the peripheral.

According to another aspect of the present invention, the attributes may include at least one of a file format and a size of the given image file.

According to another aspect of the present invention, the determining of whether the image file is to be uploaded may include at least one of determining whether or not the size of the given image file is larger than a predetermined threshold value or determining whether or not the format of the given image file is included in a predetermined type.

According to another aspect of the present invention, the printing environmental conditions may include at least one of whether the host is connected to the peripheral and whether the rendering is available on hardware provided to the peripheral.

According to another aspect of the present invention, the image forming method may further include generating an image-processed image file by rendering the given image file, if the image file is not to be uploaded and forming an image of the generated image-processed image file, wherein the generating of the image-processed image file is performed by the peripheral.

According to another aspect of the present invention, the image forming method may further include receiving a selection of whether the host performs the rendering of the given image file, and wherein the receiving is performed in the host.

According to another aspect of the present invention, the image forming apparatus includes receiving a selection of whether a host performs a rendering of a given image file; uploading the image file if the received selection indicates that the host performs the rendering; generating an image-processed image file by rendering the uploaded image file and transmitting the generated image-processed image file; and forming an image of the transmitted image-processed image file wherein the receiving of the selection, the uploading of the image file, and forming the image are performed in a peripheral, and the generating of the image-processed image file is performed in the host connected to the peripheral.

According to another aspect of the present invention, the image forming method further comprises generating an image-processed image file by rendering the given image file if the received selection indicates that the peripheral performs the rendering, and proceeding to the forming the image of the transmitted image-processed image file where the generating of the image-processed image file is performed in the peripheral.

According to another aspect of the present invention, there is provided a computer-readable medium having embodied thereon a computer program for an image forming method including determining whether or not a given image file is to be uploaded by using at least one attribute of the image file or printing environmental conditions; uploading the image file if the image file is to be uploaded; generating an image-processed image file by rendering the uploaded image file and transmitting the generated image file; and forming an image of the transmitted image-processed image file.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an image forming system according to an embodiment of the present invention; and

FIG. 2 is a flowchart for explaining an image forming method according to an embodiment of the present invention.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

An image forming system according to an aspect of the present invention includes a host (hereinafter, referred to as a host) and a peripheral connectable to the host.

The host may be a personal computer (PC), and the peripheral may be a printer or a multi-function peripheral (MFP) having a printing function.

The peripheral may receive a to-be-printed image file from the host connected thereto or by reading the to-be-printed image from a predetermined storage medium. Through such transmission, the image file is given to the peripheral.

The predetermined storage medium may be embodied as a memory card and prepared in an image pickup apparatus such as a digital camera.

If the image pickup apparatus is connected to the peripheral, the peripheral reads the image file stored in the storage medium prepared in the image pickup apparatus. The image file is preferably image data.

An example of the peripheral 120 capable of printing an image file given by reading it from the storage medium as well as an image file transmitted from the host is a photo printer.

In order to print the given image file, the peripheral must recognize the given image file. Therefore, an image file which the peripheral cannot recognize must be converted into an image file which the peripheral can recognize. Such a conversion task may be referred to as image-processing or rendering.

If the given image file is an image file given by the host, the given image file is an image file that is already rendered in the host. On the contrary, if the given image file is an image file given by reading the image file from the storage medium, the given image file is an image that is not yet rendered.

In a conventional case, the rendering of the read-out image file can be performed in only the peripheral, but according to an aspect of the present invention, the rendering of the read-out image file can be selectively performed in the host and the peripheral.

The rendering performed in the host is performed in a decoder present in the host. Here, it is preferable that the decoder be a software decoder which is implemented in a software manner.

On the other hand, the rendering performed by the peripheral is performed by a decoder present in the peripheral. In this case, the decoder can be a hardware decoder which is implemented in a hardware manner and/or a software decoder which is implemented in a software manner.

In general, a rendering speed of the hardware decoder is much faster than a rendering speed of the software decoder. If the given image file is text data, a difference between the rendering speeds may not be noticed, but if the given image file includes a large-sized data such as an image data, the difference between the rendering speeds is noticeable.

It is preferable that the rendering speed of the software decoder in the host be faster than the rendering speed of the software decoder in the peripheral.

In an aspect of the present invention, in a case where the peripheral to which only the software decoder is prepared as a decoder that prints the read-out image file, a technical construction for shortening time spent on rendering the read-out image file is proposed and described with reference to a block diagram and a flowchart.

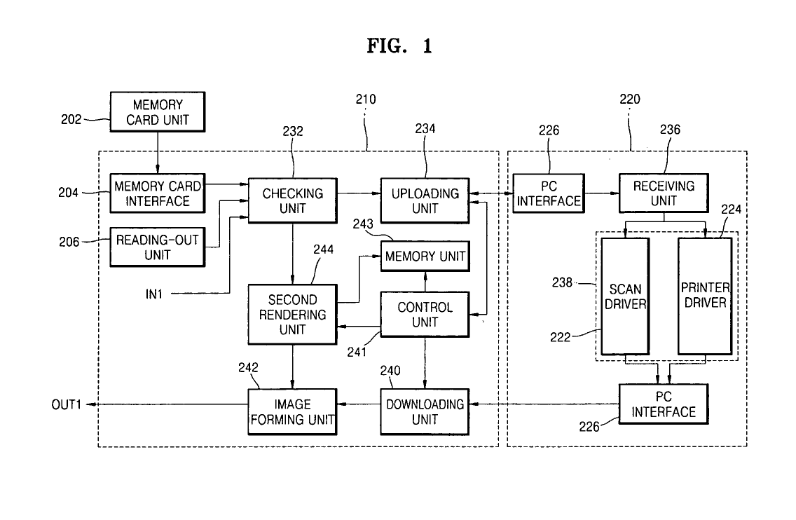

FIG. 1 is a block diagram of an image forming system according to an embodiment of the present invention. The image forming system includes a peripheral 210 and a host 220 connectable to the peripheral 210. The peripheral 210 includes a memory card interface 204, a reading-out unit 206, a checking unit 232, an uploading unit 234, a downloading unit 240, a control unit 241, a memory unit 243, an image forming unit 242, and a second rendering unit 244. The host 220 includes a PC interface 226, a receiving unit 236, and a first rendering unit 238. Here, reference numerals 210 and 220 correspond to reference numerals 120 and 110, respectively.

Here, reference number IN 1 represents an image file read by the peripheral 210. Namely, reference numeral IN 1 represents an image file which is read from a storage medium by the peripheral 210.

The peripheral 210 checks whether the read-out image file is to be uploaded by using at least one attribute and prepared printing environmental conditions of the read-out image file IN 1, transmits the image file IN 1 to the host 220 according to the checking result, and forms an image of an image-processed image file. Here, the image-processed image file represents a rendered image file.

When the image file IN 1 needs to be rendered by the host 220, the peripheral 210 does not render-process the read-out image file IN 1 but transmits the read-out image file IN 1 to the host 220 and requests that the host 220 render-process the read-out image file IN 1. Therefore, in a case where the rendering process is performed by the host 220, peripheral 210 receives printing data which is the rendered image file from the host 220.

Here, a detailed example of a case where it is determined that the rendering process needs to be performed by the host 220 will be provided while describing operations of the checking unit 232.

According to an embodiment of the present invention, the host 220 may or may not be connected to the peripheral 210. If the host 220 is connected to the peripheral 210, the host 220 renders the image file IN 1 transmitted from the peripheral 210 and transmits back to the peripheral 210, the rendered image file as the aforementioned image-processed image file.

Operations of the peripheral 210 and the host 220 will now be described in detail.

A memory card storing the image file is connected to the peripheral 210. The memory card unit 202 may be embodied as the memory card. In this case, the image files stored in the memory card is displayed by the memory card interface 204 provided to the peripheral 210. The reading-out unit 206 reads the image files stored in the memory card. IN denotes the read-out image file.

The checking unit 232 checks whether the read-out image file IN 1 is suitable for rendering or processing in the peripheral 210 or in the host 220. Namely, the checking unit 232 checks the read-out image file IN 1 and checks whether the read-out image file IN 1 needs to be subject to the rendering in the host 220.

A situation in which there is a need for the rendering to occur in the host 220 indicates a case where an estimated time spent for rendering the image file IN 1 by a decoder in the peripheral 210 exceeds a predetermined reference time.

The more image data in the image file IN 1 in comparison to text data, the larger the size of the image file IN 1. Therefore, the larger the size of the image file IN 1, the longer the estimated time spent for processing or rendering the image file.

This process is more noticeable when the software decoder of the peripheral 210 performs the rendering of the image file IN 1.

The checking unit 232 checks at least one attribute of the read-out image file IN 1 and prepared printing environmental conditions. Here, the attributes of the image file IN 1 may be a format or a size of the image file IN 1.

The format of the image file may be identified with a file extension where the image file IN 1 is contained. For example, the checking unit 232 may check whether the image file IN 1 is image data or text data.

Namely, the checking unit 232 can check that the format of the image file IN 1 is of a predetermined type. Here, the predetermined type represents a type of an image file in which the estimated time is expected to exceed a predetermined reference time. For example, the image data may be of a predetermined type, and the text data may not be of the predetermined type.

The size of the image file may be determined according to the format of the aforementioned image file. In general, the size of the text data is smaller than the size of the image data. However, since the image file is constructed with only the text data or a combination of the text data and the image data, the checking unit 232 needs to check the size of the image file IN 1.

Namely, the checking unit 232 may check whether the size of the image file IN 1 is larger than a predetermined threshold value. Here, the predetermined threshold value represents a minimum value of the size of the image files of which the estimated time is expected to exceed the predetermined reference time.

On the other hand, the printing environmental conditions represent configurations which are given to the image file IN 1. For example, the printing environmental conditions may be identified according to whether or not a hardware decoder is located in the peripheral 210, whether or not the host 220 is connected to the peripheral 210, whether or not a size of the image file IN 1 to be processed in the peripheral 210 is larger than a predetermined threshold value, and whether or not a format of the image file IN 1 to be processed in the peripheral 210 is of a predetermined type.

Particularly, the prepared printing environmental conditions represent which state the peripheral 210 and the host 220 (constituting the image forming system according to an embodiment of the present invention to which the image file IN 1 is given) are in. Namely, in the aforementioned example, whether or not a hardware decoder is in the peripheral 210 and whether or not the host 220 is connected to the peripheral 210 determine the prepared printing environmental conditions.

Even in a case where it is checked that the image film IN 1 needs to be rendered in the host 220, as a result of checking the attributes of the read-out image file IN 1 in the checking unit 232, if the host is not connected to the peripheral 210 as a result of checking the prepared printing environmental conditions, the image file cannot be uploaded to the host 220 to perform the rendering in the host 220.

In addition, even in a case where it is checked that the image film IN 1 needs to be rendered in the host 220 as a result of checking the attributes of the read-out image file IN 1 in the checking unit 232, if a hardware decoder is present in the peripheral 210 as a result of checking the prepared printing environmental conditions, although the host 220 is connected to the peripheral 210, it is preferable that the rendering be performed using the hardware decoder present in the peripheral 210.

As a result, in order to check whether or not the read-out image file IN 1 needs to be rendered in the host 220, it is preferable that the checking unit 232 checks the printing environmental conditions given to the image file IN 1. Namely, it is preferable that the checking unit 232 check the prepared printing environmental conditions as well as the attributes of the image file IN 1.

For example, only if the checking unit 232 checks that the size of the read-out image file IN 1 is larger than a predetermined threshold value, a hardware decoder is not prepared in the peripheral 210, and the peripheral 210 and the host 220 are connected to each other, then the image file IN 1 can be rendered in the host 220.

In addition, if it is checked that the host 220 is connected to the peripheral 210, the image file IN 1 may be rendered in the host 220 irrespective of the size and format of the read-out image file IN 1.

The uploading unit 234 uploads the image file IN 1 to the host 220 according to the result of the checking unit 232. More specifically, in a case where the checking unit 232 checks that the image file IN 1 needs to be rendered in the host 220, the checking unit 232 commands the uploading unit 234 to upload the image file to the host 220, and the uploading unit 234 receiving the command uploads the image file IN 1 to the host 220.

The receiving unit 236 receives an input of the image file IN 1 uploaded from the uploading unit 234 of the peripheral 210 and transmits the input image file IN 1 to a first rendering unit 238. The receiving unit 236 may operate as a kind of buffer.

The PC interface 226 provides a user with a user interface which can receive user selections on whether the rendering of the image file uploaded from the uploading unit 234 is performed in the host 220 or in the peripheral 210.

If the PC interface 226 receives the selection whether the rendering of the uploaded image file is to be performed in the host 220, the PC interface 226 inputs the uploaded image file to the receiving unit 236.

On the contrary, if the PC interface 226 receives the selection indicating that the rendering of the uploaded image file is to be performed by the peripheral 210, the PC interface 226 transmits the uploaded image file back to the uploading unit 234, and the uploading unit 234 requests a control unit 240 to command an operation of a second rendering unit 244.

The first rendering unit 238 converts the transmitted image file IN 1 into a format which the peripheral 210 can recognize. Namely, the first rendering unit 238 performs the rendering of the transmitted image file IN 1.

It is preferable that the first rendering unit 238 be implemented in a software manner in the host 220. Namely, it is preferable that the first rendering unit 238 be formed as a software decoder in the host 220.

Therefore, if the host 220 is a personal computer (PC), the rendering speed of the first rendering unit 238 is proportional to the information processing capability of a central processing unit (CPU) located in the personal computer. The first rendering unit 238 outputs printing data, that is, the rendered image file.

The first rendering unit 238 may be implemented as a scan driver 222 or a printer driver 224. The scan driver 222 is a driver located in the host 220 to drive the peripheral 210 performing a scanning function, and the printer driver 224 is a driver located in the host 220 to drive the host 220 performing a printing function.

The downloading unit 240 downloads the output printing data from the first rendering unit 238. The image forming unit 242 forms an image of the downloaded printing data. The image forming unit 242 prints the printing data to form the image.

On the other hand, the PC interface 226 provides a user with a user interface which receives a selection whether or not the printing data is downloaded to the peripheral 210.

On the other hand, in a case where the checking unit 232 checks that the image file IN 1 does not need to be rendered in the host 220, the rendering of the image file IN 1 is performed by the peripheral 210. For this purpose, a second rendering unit 244 is provided in the peripheral 210.

The second rendering unit 244 converts the image file IN 1 into a format which the peripheral 210 can recognize according to the checking result of the checking unit 232. Namely, the second rendering unit 244 performs the rendering of the image file IN 1.

More specifically, in a case where the checking unit 232 checks that the image file IN 1 does not need to be rendered in the host 220, the checking unit 232 commands an operation of a second rendering unit 244, and the command-receiving second rendering unit 244 performs the rendering of the image file IN 1.

The second rendering unit 244 transmits the printing data, that is, the rendered image file, to the image forming unit 242, and the image forming unit 242 receiving the transmitted printing data forms an image of the printing data. Here, it is preferable that the image forming unit 242 print the printing data to form the image.

As a result, OUT 1 represents the image of the printing data or a printed material on which the image is printed. Here, the printing data may be data generated by the first rendering unit 238 or the second rendering unit 244.

The control unit 241 controls operations of the uploading unit 234, the downloading unit 240, and a second rendering unit 244. In addition, the control unit 241 may command an operation of the memory unit 243. According to the command, the memory unit 243 can store various application programs to be installed in the peripheral 210, printing data generated by the second rendering unit 244, and the like.

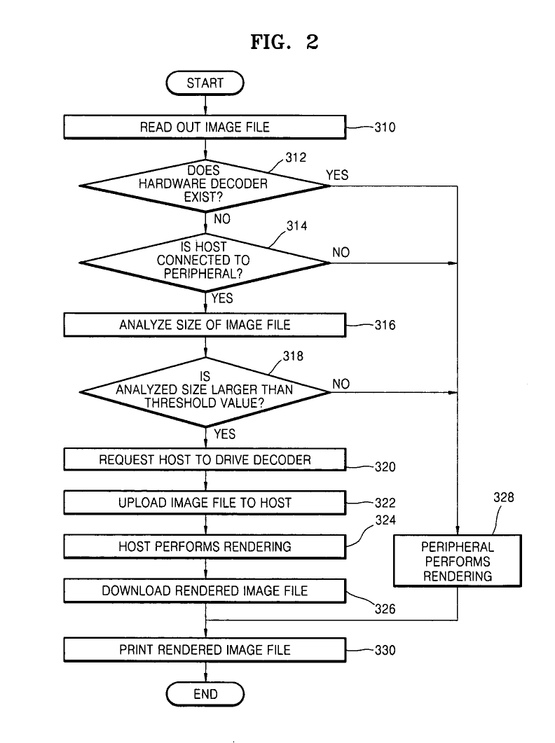

FIG. 2 is a flowchart explaining an image forming method according to an embodiment of the present invention. The image forming method includes operations 310 to 319 determining printing environmental conditions given to a read-out image file IN 1, operations 320 to 328 performing rendering of an image film in a rendering location determined according to the determination result, and operation 220 printing the rendered image file.

The image file IN 1 read from a storage medium connected to the peripheral 210 is input to the checking unit 232 (operation 310). The checking unit 232 checks whether a hardware decoder is located in the peripheral 210 (operation 312).

If determined that a hardware decoder is located in the peripheral 210 (operation 312), the checking unit 232 determines whether the host 220 is connected to the peripheral 210 (operation 314).

If determined that the host 220 is connected to the peripheral 210 (operation 314), the checking unit 232 analyzes a size of the read-out image file IN 1 (operation 316). After operation 316, the checking unit 232 determines whether the analyzed size is larger than a predetermined threshold value (operation 318).

If determined that the analyzed size is larger than the threshold value (operation 318), in a case where the image file is to be uploaded, the peripheral 210 requests the host 220 to drive a software decoder located in the host 220 (operation 320)

The uploading unit 234 uploads the read-out image file IN 1 to the receiving unit 236 of the host 220 (operation 322), and the receiving unit 236 transmits the received image file IN 1 to the first rendering unit 238.

The first rendering unit 238 of the host 220 performs the rendering of the transmitted image file IN 1 (operation 324). The downloading unit 240 downloads the printing data, that is, the rendered image file, from the first rendering unit 238 (operation 326).

On the other hand, when it is determined that a hardware decoder is not in the peripheral 210 in 312 operation, such as when the peripheral 210 and the host 220 are not connected to each other in operation 314, or in a case where the size of the image file IN 1 is equal to or less than a predetermined threshold value in operation 318, the peripheral 210 performs the rendering of the image file IN 1 without support of the host 220. The image forming unit 242 prints the printing data (operation 330).

The aspects of the invention can also be embodied as computer readable codes on a computer readable recording medium. The computer readable recording medium is any data storage device that can store data which can be thereafter read by a computer system. Examples of the computer readable recording medium include read-only memory (ROM), random-access memory (RAM), CD-ROMs, magnetic tapes, floppy disks, optical data storage devices, and carrier waves (such as data transmission through the Internet). The computer readable recording medium can also be distributed over network coupled computer systems so that the computer readable code is stored and executed in a distributed fashion. Also, functional programs, codes, and code segments for accomplishing the aspects of the present invention can be easily construed by programmers skilled in the art to which the present invention pertains.

As described above, in an image forming system and method according to an aspect of the present invention, a peripheral reading an image file does not image-process the image file by using a decoder located thereto but image-processes the image file by using a host connected thereto, so that even a large-sized image file can be rapidly image-processed. As a result, a high speed printing effect can be obtained. Particularly, since a software decoder located in the host, in a case where a large-sized image file such as image data is to be printed, the image processing capability of the software decoder located in the host is better than the image processing capability of the software decoder located in the peripheral.

While the aforementioned image forming system and method according to the aspects of the present invention have been particularly shown and described with reference to exemplary embodiments thereof, it will be understood by those skilled in the art that various changes in form and details may be made therein without departing from the spirit and scope of the present invention as defined by the appended claims.

What is claimed is:

1. An image forming system comprising:
a peripheral checking whether an input image file is to be uploaded by using at least one of attribute, and printing environmental conditions of the image file, transmitting the image file according to the result of checking whether the input image file is to be uploaded, and forming an image of an image-processed image file; and
a host connectable to the peripheral, rendering the transmitted image file, and outputting the rendered image file as the image-processed image file to the peripheral.

2. The image forming system according to claim 1, wherein the peripheral comprises:
a checking unit checking whether the image file is to be uploaded by using the at least one of attribute and the printing environmental conditions of the image file;
an uploading unit transmitting the image file according to the result of checking whether the input image file is to be uploaded; and
an image forming unit forming the image of the image-processed image file.

3. The image forming system according to claim 1, wherein the peripheral renders the image file, if determined that the image file is not to be uploaded, and forms an image of the rendered image file.

4. The image forming system according to claim 1, wherein the printing environmental conditions comprise at least one of: whether the rendering is available on hardware provided on the peripheral; and whether the host is connected to the peripheral.

5. The image forming system according to claim 1, wherein the at least one attribute comprises a file format and a size of the input image file.

6. The image forming system according to claim 1 wherein the host further comprises a PC interface which receives a selection of whether the host performs the rendering of the input image file.

7. The image forming system according to claim 1, wherein the peripheral further comprises a memory card interface displaying an image file read from a storage medium connected to the peripheral.

8. An image forming method comprising:
determining whether a given image file is to be uploaded by using at least one attribute of the image file and printing environmental conditions;
uploading the image file if the image file is to be uploaded;
generating an image-processed image file by rendering the uploaded image file and transmitting the generated image-processed image file; and
forming an image of the transmitted image-processed image file.

9. The image forming method according to claim 8, wherein the determining of whether the given image file is to be uploaded, the uploading of the image file, and the forming of the image are performed in a peripheral, and the generating of the image-processed image file is performed in a host connected to the peripheral.

10. The image forming method according to claim 8, wherein the at least one attribute comprises a file format and a size of the given image file.

11. The image forming method according to claim 10, wherein the determining of whether the given image file is to be uploaded comprises at least one of: determining whether the size of the given image file is larger than a predetermined threshold value or whether the format of the given image file is included in a predetermined type.

12. The image forming method according to claim 8, wherein the printing environmental conditions comprise at least one of: whether the host is connected to the peripheral; and whether the rendering is available on hardware provided to the peripheral.

13. The image forming method according to claim 9, further comprising generating an image-processed image file by rendering the given image file if the image file is not to be uploaded and forming an image of the generated image-processed image file, wherein the generating of the image-processed image file is performed by the peripheral.

14. The image forming method according to claim 9, further comprising receiving selection of whether the host performs the rendering of the given image file, wherein the receiving is performed in the host.

15. An image forming method comprising:
receiving a selection of whether a host performs a rendering of a given image file;
uploading the image file if the received selection indicates that the host performs the rendering;
generating an image-processed image file by rendering the uploaded image file and transmitting the generated image-processed image file; and
forming an image of the transmitted image-processed image file wherein the receiving of the selection, the uploading of the image file, and forming of the image are performed in a peripheral, and the generating of the image-processed image file is performed in the host connected to the peripheral.

16. The image forming method according to claim 15, further comprising:
generating an image-processed image file by rendering the given image file if the received selection indicates that the peripheral performs the rendering, and proceeding to the forming of the image, wherein the generating of the image-processed image file is performed in the peripheral.

17. A computer-readable medium having embodied thereon a computer program for an image forming method, the image forming method comprising:
determining whether a given image file is to be uploaded by using at least one attribute of the image file or printing environmental conditions;
uploading the image file if the image file is to be uploaded;
generating an image-processed image file by rendering the uploaded image file and transmitting the generated image-processed image file; and
forming an image of the transmitted image-processed image file.

18. The image forming system according to claim 2, wherein if the checking unit determines that the size of the image file is larger than a predetermined threshold value, determines that a hardware decoder is not in the peripheral, and determines that the peripheral and the host are connected, then the image file is rendered in the host.

19. The image forming system according to claim 2, wherein if the checking unit determines that the peripheral and the host are connected, the image file is rendered in the host irrespective of a size of the image file.

20. An image forming method comprising:
determining whether an input image file is to be uploaded and processed by a peripheral or a host by using attributes and printing environmental conditions of the image file,
transmitting the image file to the peripheral or the host according to the determination,
forming an image of an image-processed image file at the peripheral or the host; and
printing the image.

21. The method of claim 20, wherein the attributes used to determine whether the input image file is uploaded and processed by the peripheral or the host include a size of the input image file and/or a type of the input image file.

22. A computer-readable medium having embodied thereon a computer program for processing an image, the method comprising:
determining whether an input image file is to be uploaded and processed by a peripheral or a host by using attributes and printing environmental conditions of the image file,
transmitting the image file to the peripheral or the host according to the determination,
forming an image of an image-processed image file at the peripheral or the host; and
printing the image.
